(19) United States
(12) Patent Application Publication
(10) Pub. No.: US 2018/0374618 A1
(43) Pub. Date: Dec. 27, 2018

(54) COMPOSITE MATERIAL MOLDED ARTICLE, REACTOR, AND METHOD FOR MANUFACTURING COMPOSITE MATERIAL MOLDED ARTICLE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Takashi TAKADA, Yokkaichi (JP); Shintaro NANBARA, Yokkaichi (JP); Kazushi KUSAWAKE, Yokkaichi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/061,915

(22) PCT Filed: Jan. 5, 2017
(86) PCT No.: PCT/JP2017/000110

§ 371 Date: Jun. 13, 2018

(30) Foreign Application Priority Data
Jan. 7, 2016 (JP) 2016-001997

(51) Int. Cl. H01F 1/26; H01F 27/255; H01F 1/147; H01F 41/02; C22C 38/02

(52) U.S. Cl. CPC H01F 1/26; H01F 27/255; H01F 1/147; B29C 45/0001; C22C 38/02; C22C 2202/02; H01F 41/02

(57) ABSTRACT

A composite material molded article that includes soft magnetic powder; and resin containing the soft magnetic powder in a dispersed state, wherein when the composite material molded article is divided into nine portions in total such that, out of surfaces of the composite material molded article, an interlinkage surface that intersects a magnetic flux excited in the composite material molded article is equally divided into three portions in a vertical direction and three portions in a horizontal direction, in these portions, a density decrease ratio Dd of a density of a portion having a minimum density Dmin to a density of a portion having a maximum density Dmax, namely {(Dmax−Dmin)/Dmax}×100, is 1.2% or less.

The present application is the U.S. National Phase of PCT/JP2017/000110 filed Jan. 5, 2017, which claims the benefit of priority based on Japanese Patent Application No. 2016-001997 filed on Jan. 7, 2016, which are incorporated herein by reference in its entirety.

### BACKGROUND

The present disclosure relates to a composite material molded article, a reactor, and a method for manufacturing a composite material molded article.

A reactor is one of the parts used in a circuit that boosts/lowers a voltage. Reactors are used in converters to be mounted in vehicles such as hybrid cars. The reactor disclosed in JP 2013-118352A is an example of such reactors.

The reactor disclosed in JP 2013-118352A includes a coil having a pair of coil elements (wound portions), and a magnetic core having a pair of inner core portions arranged inside the coil and a pair of outer core portions that couple the end surfaces of the two inner core portions (paragraphs 0105 to 0116 in the specification). The inner core portions and the outer core portions are made of a composite material (composite material molded article) containing magnetic powder and resin. The composite material is manufactured by filling a mold with a mixture of magnetic powder and melted resin and solidifying (curing) the resin.

For example, when a magnetic core is formed by assembling a plurality of core members formed of a composite material molded article as described above, a gap member is provided between the core members in some cases in order to adjust inductance.

### SUMMARY

The composite material molded article of the present disclosure is a composite material molded article including:

a soft magnetic powder; and

a resin containing the soft magnetic powder in a dispersed state,

wherein when the composite material molded article is divided into nine portions in total such that, out of surfaces of the composite material molded article, an interlinkage surface that intersects a magnetic flux excited in the composite material molded article is equally divided into three portions in a vertical direction and three portions in a horizontal direction, at least one of the following conditions (1) to (3) is satisfied.

(1) In the above-mentioned portions, a density decrease ratio Dd of a density of a portion having a minimum density Dmin to a density of a portion having a maximum density Dmax, namely {(Dmax−Dmin)/Dmax}×100, is 1.8% or less.

(2) In the above-mentioned portions, a density increase ratio Di of a density of a portion having a maximum density Dmax to a density of a portion having a minimum density Dmin, namely {(Dmax−Dmin)/Dmin}×100, is 1.8% or less.

(3) In the above-mentioned portions, a density ratio DR of a density difference ΔD, that is, Dmax−Dmin, between a density of a portion having the maximum density Dmax and a density of a portion having the minimum density Dmin to an average density Dav, namely (ΔD/Dav)×100, is 1.8% or less.

The reactor of the present disclosure is a reactor including:

a coil obtained by winding a winding wire; and

a magnetic core around which the coil is arranged,

wherein the magnetic core includes a plurality of core members and a gap member provided between the core members, and

wherein at least one of the core members includes the above-mentioned composite material molded article of the present disclosure.

The method for manufacturing a composite material molded article of the present disclosure is a method for manufacturing a composite material molded article that includes:

injecting a mixture containing soft magnetic powder and melted resin into a mold and solidifying the resin to mold a composite material molded article,

wherein a difference Tr−Td between a temperature Tr of the melted resin and a temperature Td of the mold is 180° C. or higher.

### BRIEF DESCRIPTION OF THE DRAWINGS

FIG. 1 shows diagrams of a reactor including composite material molded articles according to Embodiment 1. The upper diagram is a schematic perspective view, and the lower diagram is an exploded perspective view.

FIG. 2 is an explanatory diagram showing density measurement portions of an inner core portion (composite material molded article) of a core member in samples of Test Example 1.

FIG. 3 shows a simulation sample of Test Example 2. The upper diagram is a schematic perspective view, and the lower diagram is a schematic perspective view of an inner core portion of this sample.

FIG. 4 is a distribution chart showing a distribution state of a magnetic flux density of Sample No. 2-100 of Test Example 2.

FIG. 5 is a distribution chart showing a distribution state of a magnetic flux density of Sample No. 2-1 of Test Example 2.

### DETAILED DESCRIPTION OF EMBODIMENTS

### Problem to be Solved by the Present Disclosure

In a case where a magnetic core including a plurality of cores and a gap member provided between the cores is used in a reactor, there is demand for a decrease in leakage flux from the gap member and an improvement in magnetic characteristics.

Therefore, an object of the present disclosure is to provide a composite material molded article that can be used to form a reactor having low leakage flux and good magnetic characteristics.

In addition, another object of the present disclosure is to provide a reactor including the above-mentioned composite material molded article.

Furthermore, yet another object of the present disclosure is to provide a method for manufacturing a composite material molded article that is used to manufacture the above-mentioned composite material molded article.

### Advantageous Effects of the Present Disclosure

The composite material molded article of the present disclosure can be used to form a reactor having low leakage flux and good magnetic characteristics.

The reactor of the present disclosure has low leakage flux and good magnetic characteristics.

The method for manufacturing a composite material molded article of the present disclosure can be used to manufacture the above-mentioned composite material molded article.

### DESCRIPTION OF EMBODIMENTS OF THE PRESENT DISCLOSURE

The inventors of the present disclosure analyzed a conventional composite material molded article in order to reduce leakage flux from a gap member in a magnetic core including a plurality of core members formed of a composite material molded article and a gap member provided between the core members. Although details will be shown using Test Examples, which will be described later, the composite material molded article was divided into nine portions in total such that an interlinkage surface of the composite material molded article that intersects the magnetic flux was equally divided into three portions in a vertical direction and three portions in a horizontal direction, and then the above analysis was performed through simulations. As a result, the following findings were obtained.

(i) The above-mentioned nine portions differed (varied) in magnetic flux density (density).

(ii) The density decrease ratio Dd of the density of a portion having the minimum density Dmin to the density of a portion having the maximum density Dmax increased in some cases.

(iii) The density increase ratio Di of the density of a portion having the maximum density Dmax to the density of a portion having the minimum density Dmin increased in some cases.

(iv) The density ratio DR of the density difference ΔD between the density of a portion having the maximum density Dmax and the density of a portion having the minimum density Dmin to the average density Dav increased in some cases.

(v) A composite material molded article having a large density decrease ratio Dd, a large density increase ratio Di, and a large density ratio DR had high leakage flux.

Based on these findings, the inventors of the present disclosure thought that leakage flux could be reduced in a composite material molded article in which at least one of the above-mentioned density decrease ratio Dd, the above-mentioned density increase ratio Di, and the above-mentioned density ratio DR was small. Therefore, the leakage flux of a composite material molded article in which the above-mentioned density decrease ratio Dd, the above-mentioned density increase ratio Di, and the above-mentioned density ratio DR in the above-mentioned nine portions were substantially zero was calculated through simulations. It was found from the results that the leakage flux thereof was lower than that of a conventional composite material molded article.

Furthermore, the inventors of the present disclosure investigated a method for manufacturing a composite material molded article in which at least one of the above-mentioned density decrease ratio Dd, the above-mentioned density increase ratio Di, and the above-mentioned density ratio DR is small. It was found from the results that such a composite material molded article was obtained by increasing a temperature difference Tr−Td between a temperature Tr of melted resin and a temperature Td of a mold compared with a conventional case. The present disclosure was achieved based on these findings. First, embodiments of the present disclosure will be listed and described.

(1) A first composite material molded article according to an aspect of the present disclosure is a composite material molded article including:

soft magnetic powder; and

resin containing the soft magnetic powder in a dispersed state,

wherein when the composite material molded article is divided into nine portions in total such that, out of surfaces of the composite material molded article, an interlinkage surface that intersects a magnetic flux excited in the composite material molded article is equally divided into three portions in a vertical direction and three portions in a horizontal direction,

in these portions, a density decrease ratio Dd of a density of a portion having a minimum density Dmin to a density of a portion having a maximum density Dmax, namely {(Dmax−Dmin)/Dmax}×100, is 1.8% or less.

With the above-mentioned configuration, the above-mentioned density decrease ratio Dd is small, and the density differences between the above-mentioned portions are substantially the same, thus making it easy to reduce variation in the magnetic flux density between the above-mentioned portions when the magnetic flux is excited in the composite material molded article. Therefore, when this composite material molded article is used for a magnetic core of a reactor, specifically, for a core member to be coupled via a gap member, a reactor in which magnetic flux is less likely to leak from the gap member is obtained.

(2) A second composite material molded article according to an aspect of the present disclosure is a composite material molded article including:

soft magnetic powder; and

resin containing the soft magnetic powder in a dispersed state,

wherein when the composite material molded article is divided into nine portions in total such that, out of surfaces of the composite material molded article, an interlinkage surface that intersects a magnetic flux excited in the composite material molded article is equally divided into three portions in a vertical direction and three portions in a horizontal direction,

in these portions, a density increase ratio Di of a density of a portion having a maximum density Dmax to a density of a portion having a minimum density Dmin, namely {(Dmax−Dmin)/Dmin}×100, is 1.8% or less.

With the above-mentioned configuration, the above-mentioned density increase ratio Di is small, and therefore, a reactor in which magnetic flux is less likely to leak from the gap member is obtained similarly to the above-mentioned first composite material molded article.

(3) A third composite material molded article according to an aspect of the present disclosure is a composite material molded article including:

soft magnetic powder; and

resin containing the soft magnetic powder in a dispersed state,

wherein when the composite material molded article is divided into nine portions in total such that, out of surfaces of the composite material molded article, an interlinkage surface that intersects a magnetic flux excited in the composite material molded article is equally divided into three portions in a vertical direction and three portions in a horizontal direction,

in these portions, a density ratio DR of a density difference ΔD, that is, Dmax−Dmin, between a density of a portion having the maximum density Dmax and a density of a portion having the minimum density Dmin to an average density Dav, namely (ΔD/Dav)×100, is 1.8% or less.

With the above-mentioned configuration, the above-mentioned density ratio DR is small, and therefore, a reactor in which magnetic flux is less likely to leak from the gap member is obtained similarly to the above-mentioned first and second composite material molded articles. The above-mentioned average density Dav is an average of the densities of the nine portions.

(4) In an embodiment of the above-mentioned first to third composite material molded articles, a ratio of the minimum density Dmin to the average density Dav, namely (Dmin/Dav)×100, is 99% or more.

When the above-mentioned ratio, (Dmin/Dav)×100, is 99% or more, the overall density is high, thus making it possible to form a magnetic core that can be used to form a reactor having good magnetic characteristics.

(5) In an embodiment of the above-mentioned first to third composite material molded articles, a ratio of the maximum density Dmax to the average density Dav, namely (Dmax/Dav)×100, is 100.6% or less.

When the above-mentioned ratio, (Dmax/Dav)×100, is 100.6% or less, at least one of the above-mentioned density decrease ratio Dd, the above-mentioned density increase ratio Di, and the above-mentioned density ratio DR is small, and therefore, the minimum density Dmin is high, and the overall density is thus high. Accordingly, a magnetic core that can be used to form a reactor having good magnetic characteristics can be formed.

(6) In an embodiment of the above-mentioned first to third composite material molded articles, the soft magnetic powder contains soft magnetic particles made of an Fe-based alloy that contains Si in an amount of 1.0 mass % or more and 8.0 mass % or less.

The Fe-based alloy containing Si in an amount of 1.0 mass % or more has a high electric resistivity and makes it easy to reduce eddy current loss. In addition, such an Fe-based alloy is harder than pure iron. Therefore, distortion is less likely to occur during a manufacturing process, and hysteresis loss is thus easily reduced, thus making it possible to further reduce iron loss. Regarding the Fe-based alloy containing Si in an amount of 8.0 mass % or less, the amount of Si is not excessively large, and both low loss and high saturation magnetization are easily achieved.

(7) In an embodiment of the above-mentioned first to third composite material molded articles, the soft magnetic powder is contained in the composite material molded article in an amount of 80 vol % or less with respect to the entirety of the composite material molded article.

When the above-mentioned content is 80 vol % or less, the ratio of the magnetic component is not excessively high. Therefore, the mold fillability can be easily ensured during molding, and the insulation between the soft magnetic particles can be improved, thus making it possible to reduce eddy current loss.

(8) In an embodiment of the above-mentioned first to third composite material molded articles, the soft magnetic powder has an average particle diameter of 5 μm or more and 300 μm or less.

When the soft magnetic powder has an average particle diameter of 5 μm or more, the soft magnetic powder is less likely to coagulate, and resin is likely to be provided between the powder particles, thus making it easy to reduce eddy current loss. When the soft magnetic powder has an average particle diameter of 300 μm or less, the size of the soft magnetic powder particles is not excessively large. Therefore, eddy current loss of the powder particles can be reduced, and eddy current loss of the composite material molded article can be thus reduced. In addition, the filling rate can be improved. Accordingly, it is easy to reduce the above-mentioned density decrease ratio Dd, the above-mentioned density increase ratio Di, and the above-mentioned density ratio DR as well as to improve the saturation magnetization of the composite material molded article.

(9) A reactor according to an aspect of the present disclosure is a reactor including:

a coil obtained by winding a winding wire; and

a magnetic core around which the coil is arranged,

wherein the magnetic core includes a plurality of core members and a gap member provided between the core members, and

at least one of the core members includes the composite material molded article according to any one of the items (1) to (8).

With the above-mentioned configuration, the magnetic core includes the above-mentioned composite material molded article, and therefore, low leakage flux and good magnetic characteristics are achieved.

(10) A method for manufacturing a composite material molded article according to an aspect of the present disclosure is a method for manufacturing a composite material molded article that includes:

a step of injecting a mixture containing soft magnetic powder and melted resin into a mold and solidifying the resin to mold a composite material molded article,

wherein a difference Tr−Td between a temperature Tr of the melted resin and a temperature Td of the mold is 180° C. or higher.

With the above-mentioned configuration, a composite material molded article that satisfies at least one of the above-described density decrease ratio Dd, the above-described density increase ratio Di, and the above-described density ratio DR can be manufactured by increasing the above-mentioned temperature difference Tr−Td. The reason for this is unclear, but it is thought that this is due to the high solidification speed of the resin in the mixture located on the outer peripheral side.

When the above-mentioned temperature difference Tr−Td is small, the solidification speed of the resin in the mixture is likely to be low. In general, the resin in the mixture located on the outer peripheral side solidifies before the resin in the mixture located at the central portion solidifies. If the solidification speed of the resin in the mixture on the outer peripheral side is low, a flowing allowance is large in which the mixture located at the central portion is drawn and flows toward the outer peripheral side before solidifying, in response to the contraction of the resin located on the outer peripheral side during cooling (solidification) until the solidification of the resin located on the outer peripheral side finishes. In response to this, the soft magnetic powder, which is a heavy element, also moves to the outer peripheral side, thus making it likely that the density at the cenral portion will decrease. As a result, the central portion does not always have the minimum density, but the central portion often has the minimum density. Thus, the difference in density between the portion having the maximum density and the portion having the minimum density is likely to be large.

In contrast, when the above-mentioned temperature difference Tr−Td is large, the solidification speed of the resin located on the outer peripheral side can be increased. This allows the resin located on the outer peripheral side to solidify before the mixture located at the central portion flows toward the outer peripheral side before solidifying, thus making it easier to reduce the above-mentioned flowing allowance. Specifically, the resin located on the outer peripheral side solidifies before the density of the central portion decreases. Therefore, it is thought that the difference in density between the portion having the maximum density and the portion having the minimum density can be reduced.

(11) In an embodiment of the above-mentioned method for manufacturing a composite material molded article, the temperature Td of the mold is 100° C. or lower.

When Td≤100° C., the condition that 180° C.≤Tr−Td is easily satisfied without an excessive rise in the temperature Tr of the resin. The fluidity of the mixture is ensured, and the temperature Tr of the resin does not excessively rise, thus making it easy to suppress the promotion of the thermal decomposition of the resin and the deterioration of the physical properties, such as strength, of the composite material molded article. In addition, it is easy to suppress yellowing of the surfaces of the composite material molded article.

(12) In an embodiment of the above-mentioned method for manufacturing a composite material molded article, the resin is polyphenylene sulfide resin, and

the temperature Td of the mold is higher than or equal to a temperature that is 10° C. lower than a glass transition point Tg of the resin, and is lower than or equal to a temperature that is 10° C. higher than a glass transition point Tg of the resin.

When the resin is polyphenylene sulfide resin, and Tg−10° C.≤Td, the temperature Td of the mold is less likely to be excessively low. Therefore, the solidification speed of the resin is not excessively high, thus making it easy to suppress the occurrence of cracks inside the composite material molded article.

When Td≤Tg+10° C., the temperature Td of the mold is less likely to be excessively high, and thus the condition that 180° C.≤Tr−Td is easily satisfied without an excessive rise in the temperature Tr of the resin. Moreover, the solidification speed is not excessively low, and the mold release property can be easily improved.

(13) In an embodiment of the above-mentioned method for manufacturing a composite material molded article, the temperature Td of the mold is lower than or equal to a temperature that is 135° C. lower than a melting point Tm of the resin.

When Td≤Tm−135° C., the temperature Td of the mold is easily lowered, and thus the condition that 180° C.≤Tr−Td is easily satisfied without an excessive rise in the temperature Tr of the resin.

(14) In an embodiment of the above-mentioned method for manufacturing a composite material molded article, the soft magnetic powder is contained in the mixture in an amount of 80 vol % or less with respect to the entirety of the mixture.

With the above-mentioned configuration, a composite material molded article that satisfies at least one of the above-described density decrease ratio Dd, the above-described density increase ratio Di, and the above-described density ratio DR can be easily manufactured. The reason for this is that the larger the above-mentioned content of the soft magnetic powder is, the less likely the mixture located at the central portion is to flow toward the outer peripheral side before solidifying while the mixture located at the outer peripheral side solidifies.

### DETAILS OF EMBODIMENTS OF THE PRESENT DISCLOSURE

Hereinafter, details of embodiments of the present disclosure will be described with reference to the drawings.

### Embodiment 1

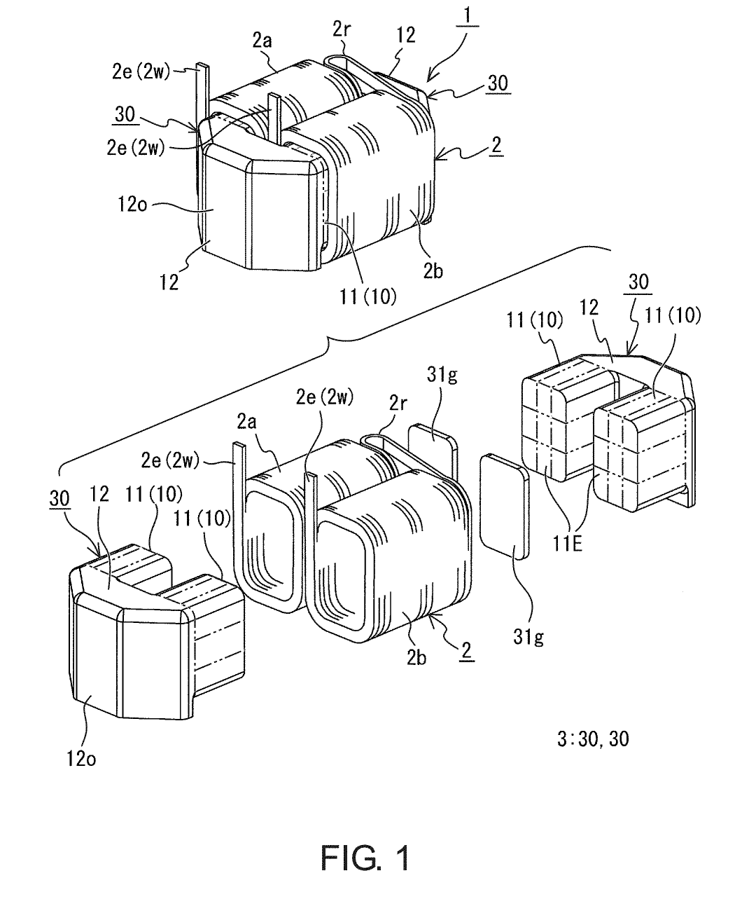

A composite material molded article 10 according to Embodiment 1 will be described with reference to FIG. 1. The composite material molded article 10 includes soft magnetic powder and resin containing the soft magnetic powder in a dispersed state. One feature of the composite material molded article 10 is that when the composite material molded article 10 is divided into nine portions in total such that an interlinkage surface that intersects the magnetic flux excited in the composite material molded article 10 is equally divided into three portions in a vertical direction and three portions in a horizontal direction, the difference in the density between the portions is small. Typically, this composite material molded article 10 constitutes at least a portion of a magnetic core 3 provided in a reactor 1. Although details will be described later, the reactor 1 includes a coil 2 and a magnetic core 3 shown in FIG. 1, for example. The coil 2 is obtained by connecting, in parallel, a pair of wound portions 2a and 2b that are each obtained by spirally winding a winding wire 2w. The magnetic core 3 is configured to have an annular shape by combining two core members 30 having the same shape and gap members 31g provided between the core members 30. Each of the core members 30 includes a pair of inner core portions 11, and an outer core portion 12 that connects the ends on one side of the inner core portions 11. In this specification, an example of the core member 30 in which the pair of inner core portions 11 is formed of the composite material molded article 10 will be described. A direction in which the pair of inner core portions 11 is arranged side-by-side is taken as a left-right (lateral) direction, and a direction intersecting both the left-right direction and a direction extending along the magnetic flux excited in the inner core portions 11 at a right angle is taken as a vertical (longitudinal) direction. In the figures, components having the same name are denoted by the same reference numeral. The long-double-short-dashed lines in FIG. 1 indicate parting lines that divide the nine portions in the inner core portion 11.

### Core Member

In the core member 30, the outer core portion 12 is integrally coupled to the ends on one side of the two inner core portions 11. The core member 30 is substantially U-shaped, as viewed from above. The two inner core portions 11 are respectively arranged inside the two wound portions 2a and 2b when the core member 30 is assembled in the coil 2 (FIG. 1). The outer core portion 12 protrudes from the end of the coil 2 when the core member 30 is assembled in the coil 2 in the same manner. The upper surfaces of the inner core portions 11 are substantially flush with the upper surface of the outer core portion 12. On the other hand, the size of the outer core portion 12 is adjusted such that the lower surface of the outer core portion 12 is located below the lower surfaces of the inner core portions 11 and is substantially flush with the lower surface of the coil 2 when the core member 30 is assembled in the coil 2.

### Inner Core Portion: Composite Material Molded Article

It is preferable that the inner core portions 11 have a shape corresponding to the shape of the coil 2 (the shape of the inner space of the coil 2). In this specification, the inner core portions 11 have a rectangular parallelepiped shape, and their corners are rounded off to fit the inner peripheral surfaces of the wound portions 2a and 2b. The surfaces of each of the inner core portions 11 are an interlinkage surface 11E that is an end surface of the inner core portion 11 and intersects the magnetic flux (at a right angle in this specification), and a peripheral surface along the peripheral direction centered around a magnetic flux (i.e., a surface along the peripheral direction of the wound portions 2a and 2b). The interlinkage surface 11E of the inner core portion 11 is continuous with the peripheral surface.

The inner core portions 11 are formed of the composite material molded article 10. That is, the overall density of each of the inner core portions 11 is substantially uniform. Specifically, when the composite material molded article is divided into nine portions in total (as indicated by the long-double-short-dashed lines in FIG. 1) such that the interlinkage surface 11E of the inner core portion 11 is equally divided into three portions in a vertical direction and three portions in a horizontal direction, at least one of the following conditions (1) to (3) is satisfied. “Equally divided into three portions” as used herein does not mean that the volume is equally divided into three portions, but means that the lengths in the longitudinal and lateral directions are equally divided into three portions. The average density Dav is an average of the densities of the nine portions.

(1) The density decrease ratio Dd₁ of the density of a portion having the minimum density Dmin to the density of a portion having the maximum density Dmax, namely {(Dmax−Dmin)/Dmax}×100, is 1.8% or less.

(2) The density increase ratio Di₁ of the density of a portion having the maximum density Dmax to the density of a portion having the minimum density Dmin, namely {(Dmax−Dmin)/Dmin}×100, is 1.8% or less.

(3) The density ratio DR₁ of the density difference ΔD₁ between the density of a portion having the maximum density Dmax and the density of a portion having the minimum density Dmin to the average density Dav, namely (ΔD₁/Dav)×100, is 1.8% or less.

When the inner core portion 11 satisfies at least one of these conditions (1) to (3), variation in the density between the above-mentioned nine portions is small, and variation in the magnetic flux density excited in the inner core portion 11 is less likely to occur. Therefore, a magnetic core in which leakage from the gap members 31g is easily suppressed can be formed, thus making it possible to form a reactor having good magnetic characteristics. The above-mentioned density decrease ratio Dd₁ is preferably 1.6% or less, more preferably 1.4% or less, and particularly preferably 1.2% or less. The above-mentioned density increase ratio Di₁ is preferably 1.6% or less, more preferably 1.3% or less, and particularly preferably 1.2% or less. The density ratio DR₁ is preferably 1.6% or less, more preferably 1.5% or less, even more preferably 1.4% or less, and particularly preferably 1.2% or less. The density difference ΔD₁ is preferably 0.10 g/cm³ or less, more preferably 0.09 g/cm³ or less, even more preferably 0.08 g/cm³ or less, even more preferably 0.07 g/cm³ or less, and particularly preferably 0.06 g/cm³ or less. The inner core portion 11 satisfies preferably two or more conditions selected from the conditions (1) to (3), and particularly preferably all of the conditions (1) to (3).

The central portion of the above-mentioned nine portions has the minimum density Dmin in many cases. However, in some cases, a portion other than the central portion has the minimum density Dmin depending on the shape of the composite material molded article 10 (inner core portion 11) and the position, shape, or size of a gate for filling a mold with the mixture during the manufacturing of the composite material molded article 10. An example of a case where a portion other than the central portion has the minimum density Dmin is a case where a portion located at a position closest to the position of the gate has the minimum density Dmin. In a case where the composite material molded article 10 has a U shape, and the gate is located at the substantially central position in the vertical and left-right directions on the outer end surface 12o of the outer core portion 12, for example, either a portion on the left of the central portion or a portion on the right of the central portion has the minimum density Dmin.

Specifically, when the pair of inner core portions 11 is viewed from the interlinkage surface 11E side, there are some cases where a portion on the right of the central portion has the minimum density Dmin in the left inner core portion 11, and a portion on the left of the central portion has the minimum density Dmin in the right inner core portion 11.

The ratio of the minimum density Dmin to the average density Dav, namely (Dmin/Dav)×100, is preferably 99% or more. When this ratio, (Dmin/Dav)×100, is 99% or more, the overall density is high, thus making it possible to form a magnetic core that can be used to form a reactor having good magnetic characteristics. This ratio, (Dmin/Dav)×100, is more preferably 99.15% or more, and particularly preferably 99.3% or more.

The minimum density Dmin is preferably 5.57 g/cm³ or more. When the minimum density Dmin is 5.57 g/cm³ or more, the overall density is high, thus making it possible to form a magnetic core that can be used to form a reactor having good magnetic characteristics. The minimum density Dmin is more preferably 5.58 g/cm³ or more, and particularly preferably 5.60 g/cm³ or more.

In general, any of the portions other than the central portions of the above-mentioned nine portions, namely any of the eight outer peripheral portions, has the maximum density Dmax. A portion of these eight portions that is located at a position farthest from the position of the gate has the maximum density Dmax. In a case where the composite material molded article 10 has a U shape, and the gate is located at the substantially central position in the vertical and left-right directions on the outer end surface 12o of the outer core portion 12, for example, when the pair of inner core portions 11 is viewed from the interlinkage surface 11E side, any of the left three portions has the maximum density Dmax in the left inner core portion 11, and any of the right three portions has the maximum density Dmax in the right inner core portion 11. In particular, when the gate is located below (above) the central position of the outer end surface 12o, the upper left (lower left) portion has the maximum density Dmax in the left inner core portion 11, and the lower right (upper right) portion has the maximum density Dmax in the right inner core portion 11.

The ratio of the maximum density Dmax to the average density Dav, namely (Dmax/Dav)×100, is preferably 100.6% or less. When this ratio, (Dmax/Dav)×100, is 99.85% or more, at least one of the above-mentioned density decrease ratio Dd₁, the above-mentioned density increase ratio Di₁, and the above-mentioned density ratio DR₁ is small, and therefore, the minimum density Dmin is high, and the overall density is thus high. In addition, the density difference ΔD₁ is also small, and therefore, the minimum density Dmin is high, and the overall density is thus high. Accordingly, a magnetic core that can be used to form a reactor having good magnetic characteristics can be formed. This ratio, (Dmax/D)×100, is more preferably 100.5% or less, and particularly preferably 100.45% or less. This ratio, (Dmax/D)×100, is preferably 99.85% or more. This ratio, (Dmax/D)×100, is more preferably 99.87% or more, and particularly preferably 99.9% or more.

The maximum density Dmax is preferably more than 5.660 g/cm³. When the maximum density Dmax is more than 5.660 g/cm³, at least one of the above-mentioned density decrease ratio Dd₁, the above-mentioned density increase ratio Di₁, and the above-mentioned density ratio DR₁ is small, and therefore, the minimum density Dmin is high, and the overall density is thus high. In addition, the density difference ΔD₁ is also small, and therefore, the minimum density Dmin is high, and the overall density is thus high. Accordingly, a magnetic core that can be used to form a reactor having good magnetic characteristics can be formed. The maximum density Dmax is more preferably 5.661 g/cm³ or more, and particularly preferably 5.663 g/cm³ or more.

In general, the outer peripheral average density Do of the eight outer peripheral portions of the above-mentioned nine portions is larger than the density Dc of the central portion. The relationship between the above-mentioned density Dc and the above-mentioned outer peripheral average density Do, namely “density Dc<outer peripheral average density Do”, is satisfied even when any of the central portion and the portions on the left and right of the central portion has the minimum density Dmin, and any of the eight outer peripheral portions has the maximum density Dmax as described above. The density decrease ratio Dd₂ of the density Dc of the central portion to the outer peripheral average density Do of the eight outer peripheral portions, namely {(Do−Dc)/Do}×100, is preferably 0.8% or less, more preferably 0.5% or less, and particularly preferably 0.3% or less. The density increase ratio Di₂ of the outer peripheral average density Do of the eight outer peripheral portions to the density Dc of the central portion, namely {(Do−Dc)/Dc}×100, is preferably 0.8% or less, more preferably 0.5% or less, and particularly preferably 0.3% or less. The density ratio DR₂ of the density difference ΔD₂, that is, Do−Dc, between the outer peripheral average density Do of the eight outer peripheral portions and the density Dc of the central portion to the average density Dav, namely (ΔD₂/Dav)×100, is preferably 0.8% or less, more preferably 0.5% or less, and particularly preferably 0.3% or less. The density difference ΔD₂ is preferably 0.04 g/cm³ or less, more preferably 0.03 g/cm³, and particularly preferably 0.02 g/cm³ The above-mentioned density Dc is preferably 5.59 g/cm³ or more, more preferably 5.60 g/cm³ or more, and particularly preferably 5.61 g/cm³ or more. The above-mentioned outer peripheral average density Do is preferably 5.63 g/cm³ or more, more preferably 5.635 g/cm³ or more, and particularly preferably 5.64 g/cm³ or more.

### Constituent Materials

### Soft Magnetic Powder

Examples of the materials for the soft magnetic powder include soft magnetic materials such as iron group metals, Fe-based alloys containing Fe as a main component, ferrites, and amorphous metals. It is preferable to use the iron group metals and the Fe-based alloys as the materials for the soft magnetic powder from the viewpoint of eddy current loss and saturation magnetization. Examples of the iron group metals include Fe, Co, and Ni. In particular, Fe is preferably pure iron (containing inevitable impurities). Since Fe has a high saturation magnetization, the saturation magnetization of the composite material can be increased as the Fe content is increased. The Fe-based alloys contain one or more elements selected from Si, Ni, Al, Co, and Cr as additional elements in an amount of 1.0 mass % or more and 20.0 mass % or less in total, and Fe and inevitable impurities as the remainder, for example. Examples of the Fe-based alloys include an Fe—Si based alloy, an Fe—Ni based alloy, an Fe—Al based alloy, an Fe—Co based alloy, an Fe—Cr based alloy, and an Fe—Si—Al based alloy (sendust). In particular, the Fe-based alloys containing Si such as the Fe—Si based alloy and the Fe—Si—Al based alloy have a high electric resistivity, easily reduce eddy current loss, and have a small hysteresis loss, thus making it possible to reduce the iron loss of the composite material molded article 10. When the Fe—Si based alloy is used, for example, the Si content is 1.0 mass % or more and 8.0 mass % or less, and preferably 3.0 mass % or more and 7.0 mass % or less. The soft magnetic powder may be a mixture of a plurality of types of powder made of different materials. An example thereof is a mixture of Fe powder and Fe-based alloy powder.

The soft magnetic powder has an average particle diameter of preferably 5 μm or more and 300 μm or less. When the soft magnetic powder has an average particle diameter of 5 μm or more, the soft magnetic powder is less likely to coagulate, and resin is easily provided sufficiently between the soft magnetic particles, thus making it easy to reduce eddy current loss. When the soft magnetic powder has an average particle diameter of 300 μm or less, eddy current loss of the powder can be reduced since the size is not excessively large, and eddy current loss of the composite material molded article 10 can be thus reduced. In addition, the filling rate can be improved, and the saturation magnetization of the composite material molded article 10 is easily improved. The average particle diameter of the soft magnetic powder is particularly preferably 10 μm or more and 100 μm or less. The average particle diameter of the soft magnetic powder can be measured by obtaining cross-sectional images using a SEM (Scanning Electron Microscope) and analyzing these images using commercially available image analysis software. At this time, an equivalent circle diameter is taken as the particle diameter. The “equivalent circle diameter” refers to a diameter of a circle having the same area as an area S of a region surrounded by the outline of the soft magnetic particle, which is determined in advance. Specifically, the equivalent circle diameter is expressed by the formula 2×{area S of region within the above-mentioned outline/n}^{1/2}.

The soft magnetic powder may be a mixture of a plurality of types of powder that differ in particle diameter. When soft magnetic powder obtained by mixing fine powder and coarse powder is used as the material for the composite material molded article 10, a low-loss reactor 1 having a high saturation magnetic flux density is easily obtained. When soft magnetic powder obtained by mixing fine powder and coarse powder is used, it is preferable that the soft magnetic powder contains different types of materials, one of which is Fe and the other of which is an Fe-based alloy, for example. When the two types of materials for powder are different, both the characteristics of Fe (high saturation magnetization) and the characteristics of an Fe-based alloy (high electric resistance that facilitates the reduction of eddy current loss) are provided, and the effect of improving saturation magnetization and iron loss are well balanced. When the two types of materials for powder are different, either the coarse powder or the fine powder may be made of Fe (Fe-based alloy), but it is preferable that the fine powder is made of Fe. In other words, it is preferable that the coarse powder is made of an Fe-based alloy. This achieves lower iron loss compared to the case where the fine powder is made of an Fe-based alloy and the coarse powder is made of Fe.

Insulating coatings made of silicone resin, a phosphate or the like may be provided on the surfaces (outer peripheries) of the soft magnetic particles in order to improve the insulation. The soft magnetic powder may be subjected to surface treatment (e.g., silane coupling treatment) for improving the compatibility with the resin or the dispersability in the resin.

The content of the soft magnetic powder in the composite material molded article 10 is preferably 80 vol % or less with respect to 100 vol % of the composite material molded article 10. When the content of the soft magnetic powder is 80 vol % or less, the ratio of the magnetic component is not excessively high, and therefore, the insulation between the soft magnetic particles can be improved, thus making it possible to reduce eddy current loss. Moreover, the mixture of the soft magnetic powder and the resin has good fluidity, and good productivity of the composite material molded article 10 is thus achieved. The content of the soft magnetic powder can be set to 30 vol % or more, for example. When the content of the soft magnetic powder is 30 vol % or more, the ratio of the magnetic component is sufficiently high. Therefore, when this composite material molded article 10 is used to form the reactor 1, saturation magnetization is easily improved. The content of the soft magnetic powder can be set to 50 vol % or more, preferably 55 vol % or more, more preferably 60 vol % or more, and particularly preferably 70 vol % or more. The content of the soft magnetic powder may be set to 75 vol % or less in particular, for example. The content of the soft magnetic powder is considered to be equivalent to the area ratio of the soft magnetic powder in the cross section of the composite material molded article. In this specification, the area ratios of the soft magnetic particles in cross-sectional images are calculated, and the average of the calculated area ratios is determined and taken as the area ratio of the soft magnetic powder in the cross section of the composite material molded article. Specifically, the average value is considered as the content (vol %) of the soft magnetic powder in the entire composite material molded article. The average particle diameter and content of the soft magnetic particles included in the composite material molded article are substantially the same as the average particle diameter and content of the soft magnetic particles included in the powder used as the raw material of the composite material molded article.

### Resin

Examples of the resin include thermosetting resins such as epoxy resin, phenol resin, silicone resin, and urethane resin, and thermoplastic resins such as polyphenylene sulfide (PPS) resin, polyamide resin (e.g., nylon 6, nylon 66, and nylon 9T), liquid crystal polymers (LCP), polyimide resin, and fluororesin. In addition, cold setting resins, bulk molding compounds (BMCs) obtained by mixing calcium carbonate or glass fiber to unsaturated polyester, millable-type silicone rubber, millable-type urethane rubber, and the like can also be used.

### Other Considerations

The composite material molded article 10 may contain powder (filler) made of a non-magnetic material such as ceramic including alumina, silica, and the like in addition to the soft magnetic powder and the resin. The filler contributes to an improvement in a heat dissipating property, and the suppression of uneven distribution of the soft magnetic powder (i.e., uniform dispersion thereof). Moreover, when a fine filler is used and provided between the soft magnetic particles, the reduction of the ratio of the soft magnetic powder due to the filler being contained can be suppressed. The content of the filler is preferably 0.2 mass % or more and 20 mass % or less, more preferably 0.3 mass % or more and 15 mass % or less, and particularly preferably 0.5 mass % or more and 10 mass % or less, with respect to 100 mass % of the composite material.

### Outer Core Portion

The outer core portion 12 has a substantially trapezoidal columnar shape. The outer core portion 12 includes upper and lower surfaces that are parallel to the magnetic flux, the outer end surface 12o that connects the upper and lower surfaces on a side opposite to the interlinkage surfaces 11E of the inner core portions 11 and that is parallel to the magnetic flux, and the inner end surface located on a side opposite to the outer end surface 12o. The inner end surface is located between the inner core portions 11 and is continuous with the inner lateral surfaces of the inner core portions 11. In this specification, the inner end surface is a flat surface that is also continuous with the lower surfaces of the inner core portions 11. The constituent materials of the outer core portion 12 is the same as that of the inner core portions 11, and the outer core portion 12 includes the above-described soft magnetic powder and resin containing the soft magnetic powder in a dispersed state. In this specification, the outer core portion 12 is made of the same material as that of the inner core portions 11, and the outer core portion 12 and the pair of inner core portions 11 are formed in series (in one piece).

### Application

The composite material molded article 10 can be favorably used for a magnetic core of various magnetic components (e.g., a reactor, a choke coil, a transformer, and a motor), and a material thereof.

### Functions and Effects of Composite Material Molded Article

With the above-described composite material molded article 10, the above-mentioned density decrease ratio Dd₁, the above-mentioned density increase ratio Di₁, and the above-mentioned density ratio DR₁ in the above-mentioned nine portions are small, and variation in the magnetic flux density excited in the composite material molded article 10 is thus small.

Therefore, when the composite material molded article 10 is used for the magnetic core 3 of the reactor 1, specifically, for the core members 30 coupled via the gap members 31g, the reactor 1 in which magnetic flux is less likely to leak from the gap members 31g is obtained. Accordingly, the composite material molded article 10 can be favorably used for the magnetic core 3 (core members 30) of the reactor 1.

### Method for Manufacturing Composite Material Molded Article

The composite material molded article 10 can be manufactured using a method for manufacturing a composite material molded article that includes a molding step of injecting an unsolidified mixture (in a fluid state) containing soft magnetic powder and melted resin into a mold and solidifying the resin to mold a composite material molded article. Examples of a method in which a mold is used to produce the material of a molded article include injection molding, heat press molding, or metal injection molding (MIM). In this method for manufacturing a composite material molded article, the above-mentioned molding step is performed in a specific temperature condition.

### Molding Step

The molding step is performed in a temperature condition that the temperature Tr of the melted resin and the temperature Td of the mold are set to specific temperatures. The composite material molded article 10 satisfying at least one of the above-described conditions (1) to (3) is thus manufactured.

### Temperature Condition

Regarding the temperature condition of the molding step, the temperature difference (Tr−Td) between the temperature Tr of the melted resin and the temperature Td of the mold can be set to satisfy the condition that “180° C.≤(Tr−Td)”, for example. When this temperature difference (Tr−Td) is higher than or equal to 180° C., the composite material molded article 10 can be manufactured. The above-mentioned temperature difference (Tr−Td) preferably further satisfies the condition that “200° C.≤(Tr−Td)”. The above-mentioned temperature difference (Tr−Td) preferably satisfies the condition that “(Tr−Td)≤250° C.”, more preferably the condition that “(Tr−Td)≤230° C.”, and particularly preferably the condition that “(Tr−Td)≤220° C.”.

Regarding the temperature Td of the mold, depending on the type of the resin, it is preferable that the condition that “Td≤100° C.” is satisfied, for example. When Td≤100° C., the temperature Td of the mold is easily lowered, and thus the condition that “180° C.≤(Tr−Td)” is easily satisfied without an excessive rise in the temperature Tr of the resin. The temperature Td of the mold is set to a temperature at which the fluidity does not excessively deteriorate. The reason for this is that the better the fluidity is, the higher the density of the obtained composite material molded article 10 is. It is preferable that the temperature Td of the mold satisfies the condition that “80° C.≤Td”.

The relationship between the temperature Td of the mold and the glass transition point Tg of the resin can be selected as appropriate depending on the type of the resin. For example, when PPS resin is used, it is preferable that the condition that “(Tg−10° C.)≤Td≤(Tg+10° C.)” is satisfied. Furthermore, it is preferable that the relationship between the temperature Td of the mold and the glass transition point Tg of the resin satisfies the condition that “Td≤Tg”.

It is preferable that the relationship between the temperature Td of the mold and the melting point Tm of the resin satisfies the condition that “Td≤(Tm−135° C.)” depending on the type of the resin. For example, when PPS resin is used, it is preferable that the relationship between the temperature Td of the mold and the melting point Tm of the resin satisfies the condition that “(Tm−155° C.)≤Td”.

When the inner core portions 11 formed of the composite material molded article 10 are integrally coupled to the outer core portion 12 as described above, it is sufficient that the temperature of a portion in the mold for forming the inner core portions 11 formed of the composite material molded article 10 and the temperature Tr of the resin satisfy the above-mentioned relationship. Specifically, the temperature of a portion in the mold for forming the outer core portion 12 and the temperature Tr of the resin may or may not satisfy the above-mentioned relationship. When the temperatures of the portions in the mold for forming the core portions 11 and 12 are made different, a mold is used in which a parting surface is located at the border between the outer core portion 12 and the pair of inner core portions 11, and the temperature of a portion in the mold for molding the outer core portion 12 and the temperature of a portion for molding the inner core portions 11 can be controlled independently. For example, the portion in the mold for molding the outer core portion 12 and the portion for molding the inner core portions 11 are provided with separate temperature controlling apparatuses. Specific examples of the temperature controlling apparatuses include a heater and a heating medium circulating system. The mold removal direction of this mold extends in the direction in which the outer core portion 12 and the pair of inner core portions 11 are lined up (i.e., the direction that is parallel to the peripheral surfaces and intersects the interlinkage surfaces 11E at a right angle). In this case, the peripheral surfaces of the inner core portions 11 are sliding contact surfaces that come into sliding contact with the inner surface of the mold, and the interlinkage surfaces 11E are non sliding contact surfaces that do not come into sliding contact with the inner surface of the mold.

### Application

The method for manufacturing a composite material molded article can be favorably used to manufacture the above-mentioned composite material molded article.

### Functions and Effects of Method for Manufacturing Composite Material Molded Article

With the above-described manufacturing method, when the temperatures are controlled based on a specific temperature condition, the composite material molded article 10 in which at least one of the above-mentioned density decrease ratio Dd₁, the above-mentioned density increase ratio Di₁, and the above-mentioned density ratio DR₁ is small can be manufactured merely by injecting the mixture into the mold and solidifying the resin. Therefore, with the above-described manufacturing method, this composite material molded article 10 can be easily manufactured, and good productivity of the composite material molded article 10 is thus achieved.

### Reactor

As described at the beginning of Embodiment 1, the reactor 1 includes the coil 2 including the pair of wound portions 2a and 2b and the magnetic core 3 constituted by the two core members 30 having the same shape and the gap members 31g provided between the core members (FIG. 1). The pair of inner core portions 11 of each of the core members 30 is constituted by the above-described composite material molded articles 10.

### Coil

The pair of wound portions 2a and 2b are obtained by spirally winding the winding wire 2w, which is a single continuous wire having no joined portions, and are coupled to each other via a coupling portion 2r. A coated flat wire in which a flat wire made of copper is used as a conductor and an insulating coating made of enamel (typically polyamideimide) is provided on the outer periphery of the conductor can be used as the winding wire 2w. Each of the wound portions 2a and 2b is constituted by an edgewise coil obtained by winding this coated flat wire in an edgewise manner. The wound portions 2a and 2b are arranged in parallel (in a lateral direction) such that their axis directions are parallel to each other. The wound portions 2a and 2b have the same winding number and have a hollow tubular shape (quadrilateral tube). The end surfaces of the wound portions 2a and 2b have a shape obtained by rounding the corners of a rectangular frame. The coupling portion 2r is formed by bending a portion of the winding wire into a U shape at one end of the coil 2 (right side of the plane of FIG. 1). Both end portions 2e of the winding wire 2w of the wound portions 2a and 2b extend from the turn forming portion. Both end portions 2e are connected to terminal members (not shown), and an external apparatus (not shown) such as a power source that supplies power to the coil 2 is connected via these terminal members.

### Magnetic Core

The magnetic core 3 is constituted by one core member 30 and the other core member 30, and the gap members 31g provided between the interlinkage surfaces 11E (end surfaces) of the inner core portions 11 in the core members 30. The magnetic core 3 having an annular shape is formed by coupling the interlinkage surfaces 11E via the gap members 31g inside the wound portions 2a and 2b. With this coupling of the core members 30, when the coil 2 is excited, a closed magnetic circuit is formed, and the magnetic flux extends parallel to the longitudinal direction of the inner core portions 11 and intersects the interlinkage surfaces at a right angle. The inner core portions 11 are formed of the above-described composite material molded article 10, thus making it possible to reduce leakage flux from the gap members 31g.

A plate material made of a material having a magnetic permeability lower than that of the core members 30 is used as the gap member 31g, for example. Examples of a material having a magnetic permeability lower than that of the core members 30 include non-magnetic materials such as alumina, and mixtures containing a non-magnetic material such as PPS resin and a magnetic material (e.g., iron powder). When the gap members 31g are formed of a plate material, the core members 30 and the gap members 31g are bonded using an adhesive, for example. Favorable examples of the adhesive that can be used include insulating adhesives such as thermosetting adhesives (e.g., epoxy resin and silicone resin), thermoplastic adhesives (e.g., PPS resin), and acrylate-based ultraviolet-curable (photocurable) adhesives. It should be noted that a clearance (air gap) is formed instead of providing the gap member.

### Application

The reactor 1 can be favorably used in constituent components of various types of converters such as vehicle-mounted converters (typically DC-DC converters) to be mounted in vehicles including hybrid cars, plug-in hybrid cars, electric cars, fuel cell cars, and the like, and converters for an air conditioner, and constituent components of power conversion devices.

### Functions and Effects of Reactor

With the above-described reactor 1, the inner core portions 11 of the magnetic core 3 have a uniform density, and therefore, leakage flux from the gap members 31g is reduced. Accordingly, the reactor 1 has good magnetic characteristics.

### Test Example 1

Samples of composite material molded articles including soft magnetic powder and resin containing the soft magnetic powder in a dispersed state were prepared. Each of the composite material molded articles was divided into a plurality of portions, and the density of each portion was measured.

### Samples No. 1-1 to No. 1-4

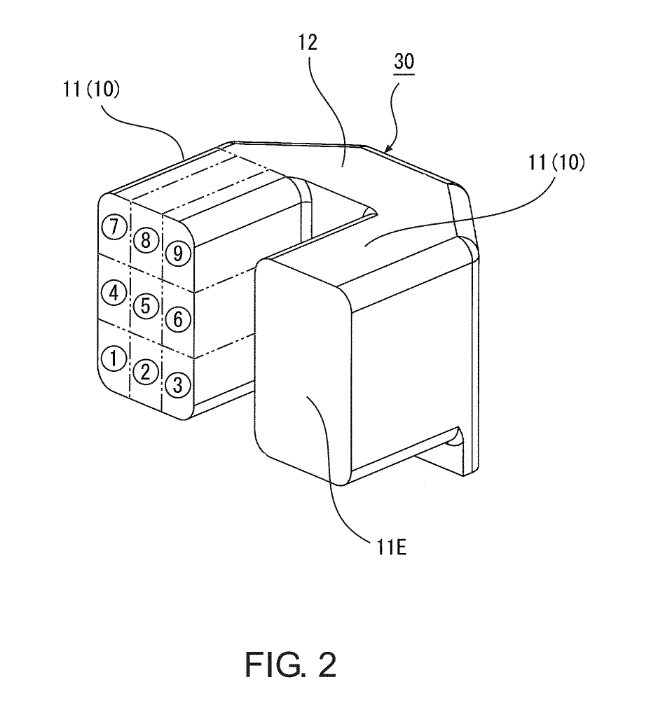

As composite material molded articles of Samples No. 1-1 to No. 1-4, a U-shaped core member 30 including a pair of inner core portions 11 made of the composite material molded article 10 described in Embodiment 1 above and an outer core portion 12 as shown in FIG. 2 was produced through a raw material preparation step and the molding step.

### Raw Material Preparation Step

In the raw material preparation step, a mixture of soft magnetic powder and resin was prepared. Fe—Si alloy powder having an average particle diameter of 80 μm and containing Si in an amount of 6.5 mass % and Fe and inevitable impurities as the remainder was used as the soft magnetic powder. PPS resin (glass transition point Tg=90° C., melting point Tm=235° C.) was used as the resin. The soft magnetic powder and the resin were mixed, and then the resin was melted. In this state, the resin and the soft magnetic powder were kneaded together to produce a mixture. In each of the samples, the content (vol %) of the soft magnetic powder in the mixture was set to a value shown in Table 1.

### Molding Step

In the molding step, a U-shaped core member 30 including a pair of inner core portions 11 and an outer core portion 12 was produced through injection molding. A mold in which a parting surface is located at the border between the outer core portion 12 and the pair of inner core portions 11 was used and was filled with the above-mentioned mixture, and then the mixture was cooled and solidified. The core member 30 was thus produced. That is, the mold removal direction extended in the direction in which the outer core portion 12 and the pair of inner core portions 11 were lined up (i.e., the longitudinal direction of the inner core portions). Although not shown in the drawings, the gate of this mold was provided at a position that was located slightly below the substantially central position in the vertical and left-right directions of the outer end surface of the outer core portion. This mold was provided with a temperature controlling apparatus that can independently control the temperature of a portion for molding the outer core portion 12 and the temperature of a portion for molding the inner core portions 11. In this specification, the temperature Tr of melted resin in the mixture and the temperature Td of the portion in the mold for molding the inner core portions 11 were varied as shown in Table 1. The temperature of the portion in the mold for molding the outer core portion 12 was set to 130° C.

TABLE 1

| | Soft | | | | | | |
|---|---|---|---|---|---|---|---|
| | magnetic powder | | Resin | | | Molding step | |
| | | Content | | Tg | Tm | Td | Tr |
| Sample No. | Composition | (vol %) | Type | (° C.) | (° C.) | (° C.) | (° C.) |
| 1-1 | Fe—6.5Si | 70 | PPS | 90 | 235 | 130 | 280 |
| 1-2 | Fe—6.5Si | 70 | PPS | 90 | 235 | 110 | 280 |
| 1-3 | Fe—6.5Si | 70 | PPS | 90 | 235 | 100 | 280 |
| 1-4 | Fe—6.5Si | 70 | PPS | 90 | 235 | 80 | 280 |

### Measurement of Density

The inner core portion of the core member of each sample was divided into nine portions in total such that the interlinkage surface 11E was equally divided into three portions in the vertical direction and three portions in the horizontal direction as shown in FIG. 2. Then, the density of each portion (g/cm³) was measured, and the average density Dav of the nine portions was calculated. In FIG. 2, the long-double-short-dashed lines indicate cut positions, and the circled numbers indicate portion numbers. An apparent density calculated from the size and mass was taken as the density of each portion. Table 2 shows the results. In this specification, the densities of the portions of the inner core portion 11 located on the left as viewed from the interlinkage surface 11E side were measured. However, when the right inner core portion 11 is divided into nine portions in the same manner, the densities of these portions substantially correspond to the bilateral symmetry of the portions of the left inner core portion 11.

The following values (1) to (9) were calculated from the densities of the measured portions. Table 3 shows the results.

(1) The density decrease ratio Dd₁ of the density of a portion having the minimum density Dmin to the density of a portion having the maximum density Dmax, namely {(Dmax−Dmin)/Dmax}×100.

(2) The density increase ratio Di₁ of the density of a portion having the maximum density Dmax to the density of a portion having the minimum density Dmin, namely {(Dmax−Dmin)/Dmin}×100.

(3) The density ratio DR₁ of the density difference ΔD₁, that is, Dmax−Dmin, between the density of a portion having the maximum density Dmax and the density of a portion having the minimum density Dmin to the average density Dav, namely (ΔD₁/Dav)×100.

(4) The density difference ΔD₁, namely Dmax−Dmin.

(5) The ratio of the minimum density Dmin to the average density Dav, namely (Dmin/Dav)×100.

(6) The ratio of the maximum density Dmax to the average density Dav, namely (Dmax/Dav)×100.

(7) The outer peripheral average density Do of the eight outer peripheral portions (No 1 to No. 4, and No. 6 to No. 9).

(8) The density difference ΔD₂, that is, Do−Dc, between the outer peripheral average density Do and the density Dc of the central portion (No. 5).

(9) The density ratio DR₂ of the density difference ΔD₂ to the average density Dav, namely (ΔD₂/Dav)×100.

TABLE 2

| | Density (g/cm³) | | | | | | | | | |
|---|---|---|---|---|---|---|---|---|---|---|
| | Portion No. | | | | | | | | | |
| Sample No. | 1 | 2 | 3 | 4 | 5 (Dc) | 6 | 7 | 8 | 9 | Dav |
| 1-1 | 5.648 | 5.629 | 5.622 | 5.637 | 5.563 | 5.542 | 5.654 | 5.629 | 5.623 | 5.616 |
| 1-2 | 5.649 | 5.63 | 5.623 | 5.638 | 5.58 | 5.555 | 5.66 | 5.629 | 5.624 | 5.621 |
| 1-3 | 5.649 | 5.637 | 5.631 | 5.642 | 5.607 | 5.584 | 5.663 | 5.634 | 5.623 | 5.63 |
| 1-4 | 5.648 | 5.64 | 5.64 | 5.645 | 5.627 | 5.604 | 5.663 | 5.644 | 5.633 | 5.638 |

TABLE 3

| Sample | Dd₁ | Di₁ | DR₁ | ΔD₁ | (Dmin/Dav) × | (Dmax/Dav) × | Do | ΔD₂ | DR₂ |
|---|---|---|---|---|---|---|---|---|---|
| No. | (%) | (%) | (%) | (g/cm³) | 100 (%) | 100 (%) | (g/cm³) | (g/cm³) | (%) |
| 1-1 | 1.981 | 2.021 | 1.994 | 0.112 | 98.68 | 100.67 | 5.623 | 0.060 | 1.068 |
| 1-2 | 1.855 | 1.890 | 1.868 | 0.105 | 98.83 | 100.70 | 5.626 | 0.046 | 0.818 |
| 1-3 | 1.395 | 1.415 | 1.403 | 0.079 | 99.18 | 100.59 | 5.633 | 0.026 | 0.462 |
| 1-4 | 1.042 | 1.053 | 1.046 | 0.059 | 93.39 | 100.44 | 5.640 | 0.013 | 0.231 |

In Samples No. 1-3 and No. 1-4 in which the temperature difference (Tr−Td) between the temperature Tr of the melted resin and the temperature Td of the mold satisfied the condition that “180° C.≤(Tr−Td)” in the molding step as shown in Table 1, the density decrease ratio Dd₁ was smaller than or equal to 1.8%, the density increase ratio Di₁ was smaller than or equal to 1.8%, and the density ratio DR₁ was smaller than or equal to 1.8% as shown in Table 3. In Samples No. 1-3 and No. 1-4, the density difference ΔD₁ was smaller than or equal to 0.10 (g/cm³) as shown in Table 3. In addition, in Samples No. 1-3 and No. 1-4, (Dmin/Dav)×100 was larger than or equal to 99%, and (Dmax/Dav)×100 was smaller than or equal to 100.6% as shown in Table 3. Furthermore, in Samples No. 1-3 and No. 1-4, the outer peripheral average density Do was larger than or equal to 5.630 g/cm³ as well as larger than or equal to the density Dc, and the density difference ΔD₂ was smaller than or equal to 0.04 g/cm³. Moreover, in Sample No. 1-3 and No. 1-4, the density ratio DR₂ was smaller than or equal to 0.8%. Specifically, both Samples No. 1-3 and No. 1-4 included the inner core portions 11 having a high density and a small density variation. It was found from these results that when the above-mentioned temperature difference (Tr−Td) was large, the density could be increased, and the density variation could be reduced.

On the other hand, in samples No. 1-1 and No. 1-2 in which the above-mentioned temperature difference (Tr−Td) satisfied the condition that “(Tr−Td)≤180° C.” in the molding step, the density decrease ratio Dd₁ was larger than 1.8%, the density increase ratio Di₁ was larger than 1.8%, and the density ratio DR₁ was larger than 1.8% as shown in Table 3. In Samples No. 1-1 and No. 1-2, the density difference ΔD₁ was larger than 0.10 (g/cm³). In addition, in Samples No. 1-1 and No. 1-2, (Dmin/Dav)×100 was smaller than 99%, and (Dmax/Dav)×100 was larger than 100.6% as shown in Table 3. Furthermore, in Samples No. 1-1 and No. 1-2, the outer peripheral average density Do was smaller than 5.630 g/cm³, and the density difference ΔD₂ was larger than 0.04 g/cm³. Specifically, it was found that the densities of the inner core portions 11 of Samples No. 1-1 and 1-2 were less uniform than those of Samples No. 1-3 and No. 1-4. It was found from these results that when the above-mentioned temperature difference (Tr−Td) was small, the density variation was large.

### Test Example 2

The amount of leakage flux depending on the variation in the density decrease ratio Dd₁ of the inner core portion was investigated through simulations. In this specification, Samples No. 2-100, and No. 2-1 to No. 2-4 for the evaluation of leakage flux were not manufactured in practice, but their magnetic characteristics were determined using simulation software. The density distribution of the inner core portion in Sample No. 2-100 was set to be uniform, and the density distributions of the inner core portions in Samples No. 2-1 to No. 2-4 were respectively set to correspond to those in Samples No. 1-1 to No. 1-4 of Test Example 1.

### Sample No. 2-100, Samples No. 2-1 to No. 2-4

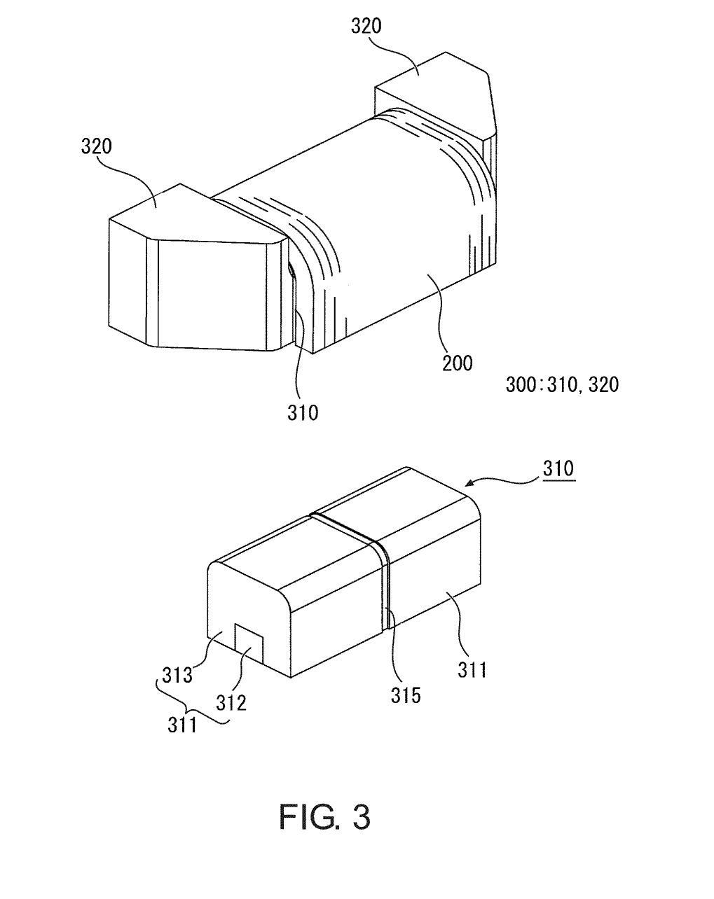

As shown in FIG. 3, each sample was constituted by a coil 200 and a magnetic core 300 including a single inner core portion 310 and two outer core portions 320. The coil 200 was formed into a semi-cylindrical shape as shown in the upper diagram in FIG. 3. The inner core portion 310 was arranged inside the coil 200 and was constituted by two core pieces 311 that were lined up in the axial direction and a gap member 315 provided between the two core pieces 311 as shown in the lower diagram in FIG. 3. Each of the core pieces 311 included a central portion 312 having a quadrangular prism shape, and an outer peripheral portion 313 surrounding three sides of the four sides of the central portion 312. The two outer core portions 320 were arranged on the outside of the coil 200 and were coupled to the end surfaces of the inner core portion 310.

The densities of the central portions 312 and the outer peripheral portions 313 of the samples were varied. In Sample No. 2-100, the central portion 312 and the outer peripheral portions 313 had the same density. The central portions 312 in Samples No. 2-1 to No. 2-4 respectively had the same densities as those of the portions having the minimum density Dmin in Samples No. 1-1 to No. 1-4, and the outer peripheral portions 313 in Samples No. 2-1 to No. 2-4 respectively had the same densities as those of the portions having the maximum density Dmax in Samples No. 1-1 to No. 1-4.

### Evaluation of Leakage Flux

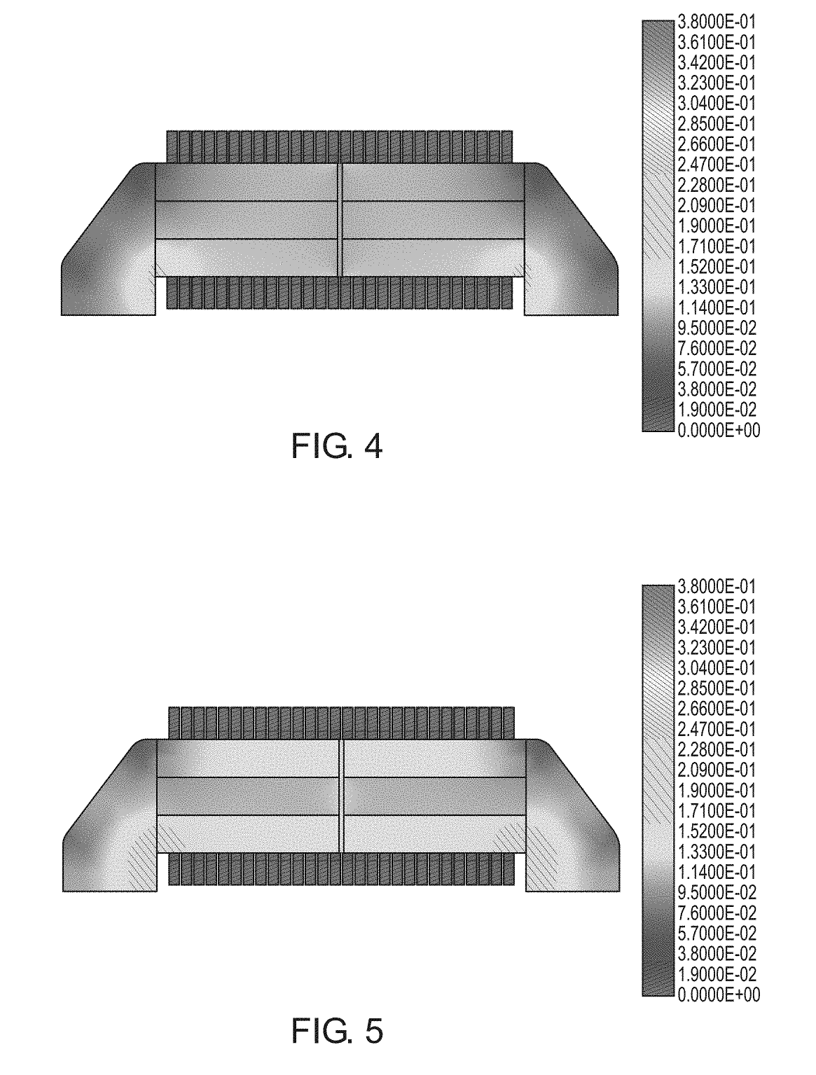

The leakage flux was evaluated by evaluating the influence of the density decrease ratio Dd₁ of the density of a portion having the minimum density Dmin to the density of a portion having the maximum density Dmax, namely {(Dmax−Dmin)/Dmax}×100, on leakage loss. Large leakage loss causes high leakage flux, and small leakage loss causes low leakage flux. The leakage loss was determined using known simulation software that can indicate the distribution of the magnetic flux density (i.e., the magnitude of the magnetic flux density) using various colors (red, orange, yellow, green, blue, indigo, and purple in decreasing order of the magnetic flux density). Table 4 shows the results. In this table, the leakage losses of Samples No. 2-1 to No. 2-4 were expressed as a ratio to the leakage loss of Sample No. 2-100, which was taken as 100. As representatives, FIGS. 4 and 5 respectively show the distributions of the magnetic flux density in Samples No. 2-100 and No. 2-1 (corresponding to Sample No. 1-1) that were determined through simulations. Although FIGS. 4 and 5 show gray-scale images, these images are colored in the above-mentioned various colors in practice.

TABLE 4

| | | Leakage loss |
|---|---|---|
| Sample No. | Dd₁ (%) | (ratio) |
| 2-100 | 0 | 100 |
| 2-1 | 2.0 | 110 |
| 2-2 | 1.9 | 110 |
| 2-3 | 1.4 | 103 |
| 2-4 | 1.0 | 102 |

As shown in Table 4, in Samples No. 2-3 and No. 2-4 in which the above-mentioned condition that Dd₁≤1.8% was satisfied, the leakage loss was 103 or less and was thus small, whereas in Samples No. 2-1 and No. 2-2 in which the above-mentioned Dd₁ was larger than 1.8%, the leakage loss was 110 or more and was thus large. Therefore, it was found that the leakage flux was lower in Samples No. 2-3 and No. 2-4 than in Samples No. 2-1 and No. 2-2.

It was found from these results that the leakage flux was low in Samples No. 2-3 and No. 2-4 corresponding to Samples No. 1-3 and No. 1-4, and therefore, the leakage flux was also low in Samples No. 1-3 and No. 1-4.

Substantially the entire region of the inner core portion of Sample No. 2-100 in which the above-mentioned Dd₁ was zero was uniformly colored in bluish green as shown in FIG. 4. Although not shown in diagrams, the coil was colored in substantially the same purple over the entire length in the axial direction, and in the coil, a portion near the gap member and portions located between the gap member and the outer core portions were colored in substantially the same purple. That is, the inner core portion of Sample No. 2-100 in which the above-mentioned density difference was not formed had little influence on the magnetic flux of the coil, and it was thus found that the leakage flux from the gap member was low.

On the other hand, in the inner core portion of Sample No. 2-1 in which the above-mentioned Dd₁ was larger than 1.8%, the central portion and the outer peripheral portion were colored in different colors as shown in FIG. 5. Specifically, the central portion was colored in a color between blue and light blue, whereas the outer peripheral portion was colored in bluish green. Although not shown in the diagrams, in the coil, portions located between the gap member and the outer core portions were colored in purple, whereas a portion near the gap member was colored in colors from purple to indigo. It is thought that this was because the magnetic flux leaked from the gap member and had an influence on the coil. It is thought that this resulted in the large leakage loss as shown in Table 4 above.

The present disclosure is not limited to these embodiments and is defined by the scope of the appended claims, and all changes that fall within the same essential spirit as the scope of the claims are intended to be included therein. For example, the shape of the core member can be selected as appropriate depending on the combinations of a plurality of core members in a magnetic core. A plurality of core members can be combined to form a so-called L-L (J-J) type core in which one inner core portion is integral with the outer core portion, other than the above-described U—U type core. Moreover, a reactor including a coil with a single wound portion and a magnetic core called an E-E type core or an E-I type core can also be formed.

1. A composite material molded article comprising:
a soft magnetic powder; and
a resin containing the soft magnetic powder in a dispersed state,
wherein when the composite material molded article is divided into nine portions in total such that, out of surfaces of the composite material molded article, an interlinkage surface that intersects a magnetic flux excited in the composite material molded article is equally divided into three portions in a vertical direction and three portions in a horizontal direction, and
in the nine portions, a density decrease ratio Dd of a density of a portion having a minimum density Dmin to a density of a portion having a maximum density Dmax, namely {(Dmax−Dmin)/Dmax}×100, is 1.2% or less.

2. A composite material molded article comprising:
a soft magnetic powder; and
a resin containing the soft magnetic powder in a dispersed state,
wherein when the composite material molded article is divided into nine portions in total such that, out of surfaces of the composite material molded article, an interlinkage surface that intersects a magnetic flux excited in the composite material molded article is equally divided into three portions in a vertical direction and three portions in a horizontal direction, and
in the nine portions a density increase ratio Di of a density of a portion having a maximum density Dmax to a density of a portion having a minimum density Dmin, namely {(Dmax−Dmin)/Dmin}×100, is 1.3% or less.

3. A composite material molded article comprising:
a soft magnetic powder; and
a resin containing the soft magnetic powder in a dispersed state,
wherein when the composite material molded article is divided into nine portions in total such that, out of surfaces of the composite material molded article, an interlinkage surface that intersects a magnetic flux excited in the composite material molded article is equally divided into three portions in a vertical direction and three portions in a horizontal direction, and
in the nine portions, a density ratio DR of a density difference ΔD, that is, Dmax−Dmin, between a density of a portion having the maximum density Dmax and a density of a portion having the minimum density Dmin to an average density Dav, namely (ΔD/Dav)×100, is 1.4% or less.

4. The composite material molded article according to claim 1, wherein a ratio of the minimum density Dmin to the average density Dav, namely (Dmin/Dav)×100, is 99% or more.

5. The composite material molded article according to claim 1, wherein a ratio of the maximum density Dmax to the average density Dav, namely (Dmax/Dav)×100, is 100.6% or less.

6. The composite material molded article according to claim 1, wherein the soft magnetic powder contains soft magnetic particles made of an Fe-based alloy that contains Si in an amount of 1.0 mass % or more and 8.0 mass % or less.

7. The composite material molded article according to claim 1, wherein the soft magnetic powder is contained in the composite material molded article in an amount of 80 vol % or less with respect to the entirety of the composite material molded article.

8. The composite material molded article according to claim 1, wherein the soft magnetic powder has an average particle diameter of 5 μm or more and 300 μm or less.

9. A reactor comprising:
a coil obtained by winding a winding wire; and
a magnetic core around which the coil is arranged,
wherein the magnetic core includes a plurality of core members and a gap member provided between the core members, and
at least one of the core members includes the composite material molded article according to claim 1.

10. A method for manufacturing a composite material molded article, comprising:
injecting a mixture containing soft magnetic powder and melted resin into a mold and solidifying the resin to mold a composite material molded article,
wherein the soft magnetic powder is contained in the mixture in an amount of 80 vol % or less with respect to the entirety of the mixture,
wherein a difference Tr−Td between a temperature Tr of the melted resin and a temperature Td of the mold is 200° C. or higher, and
wherein the temperature Td of the mold is lower than or equal to a glass transition point Tg of the resin and 100° C. or lower.

11. (canceled)

12. The method for manufacturing a composite material molded article according to claim 10,
wherein the resin is polyphenylene sulfide resin, and
wherein the temperature Td of the mold is higher than or equal to a temperature that is 10° C. lower than a glass transition point Tg of the resin, and is lower than or equal to a temperature that is 10° C. higher than a glass transition point Tg of the resin.

13. The method for manufacturing a composite material molded article according to claim 10, wherein the temperature Td of the mold is lower than or equal to a temperature that is 135° C. lower than a melting point Tm of the resin.

14. (canceled)
